(19) United States
(12) Patent Application Publication
(10) Pub. No.: US 2005/0282137 A1
(43) Pub. Date: Dec. 22, 2005

(54) System and method using visual or audio-visual programming for life science educational and research purposes

(75) Inventors: Maciek Sasinowski, Williamsburg, VA (US); Krista Miller, Williambsburg, VA (US); Heather Sasinowska, Williamsburg, VA (US); Jason Miller, Williamsburg, VA (US); Kristina Gleason, Williamsburg, VA (US)

Correspondence Address: GUERRY LEONARD GRUNE, 784 S VILLIER CT., VIRGINIA BEACH, VA, 23452, US

(73) Assignee: Incogen, Inc., Williamsburg, VA (US)

(21) Appl. No.: 10/872,056

(22) Filed: Jun. 19, 2004

(51) Int. Cl. G09B 3/00

(52) U.S. Cl. 434/350

(57) ABSTRACT

The current invention is a visual or audio-visual programming environment for life science and bioinformatics developed for educational purposes. This programming environment incorporates novel educational features including: an integrated overview page, quick reference guide, introductory video, hot-linked glossary, intelligent personalized tutor, library of primers, multimedia tutorials, entertainment features, educational error messages, tracking system(s), multimedia assessment(s), and a lesson planner. The supporting client-server as well as client-only architecture includes drag-and-drop workflow pipeline construction for bioinformatics analysis using built-in user-defined or third party services (modules) as well as a software development kit (SDK), sharing and auto-update utility.

### BACKGROUND OF THE INVENTION

1. Field of Invention

The current invention is a life science visual programming tool specifically designed for classroom use that revolutionizes life science training at undergraduate and graduate university and college institutions, as well as in secondary school systems, and has the potential for use as an ‘on-the-job’ training tool.

The present invention involves the use of a visual or audio-visual programming environment for life sciences education. Currently there exists a significant shortage of trained personnel with the necessary skill set to extract knowledge and derive benefits from data generated in life science research experiments. The shortage of such personnel is due, in large part, to a lack of formal life science informatics or bioinformatics training programs within higher educational establishments. The lack of formal training and qualified bioinformaticists creates a significant bottleneck in the discovery process because it impairs the ability to fully exploit the vast amounts of data that are produced at pharmaceutical and agricultural research facilities as well as in government and academic laboratories.

Many universities and colleges recognize the importance of bioinformatics training as a critical component of the life sciences education and discovery processes and are introducing relevant courses and degrees into their curricula. However, the lack of adequate bioinformatics training tools presents significant challenges to life science and bioinformatics education and impedes the ability to produce qualified bioinformaticists.

Moreover, there are a number of resources in the form of software applications implementing complex algorithms available for life science and bioinformatics analysis that exist both as web-enabled tools and as independent software modules. The use of many of these tools in complex analysis workflows and the visualization of the results, however, require a significant level of programming expertise. It is not efficient to integrate all of the modules for life science and bioinformatics analysis into a single monolithic and proprietary application, as the analytical methods used by researchers in this field are rapidly expanding and evolving. As new techniques are discovered for life science and bioinformatics, analytical software modules must be advanced to perform more complex analysis and data mining tasks.

Hence, there is a need for an extensible, user-friendly programming environment which could integrate these software applications when they become available into a user-friendly programming environment which integrates appropriate software applications such that scientists and bioinformaticists can perform their tasks more efficiently without the requirement of expertise in computer programming.

Moreover, in addition to integrating and providing easy access to heterogeneous tools in such a manner, the programming environment should also enable the end user to understand the purpose and appropriate application of each tool as well as to decipher the results of the analysis and guide the user in extracting relevant knowledge from the data.

2. Description of Prior Art

Many researchers and private companies have attempted to produce an all-encompassing, monolithic solution for genomic analysis that claimed to provide all the necessary tools. For example TurboWorx® Inc. offers a tool known as TurboWorx Builder® for life science and bioinformatics analysis. Scitegic provides a tool known as Pipeline Pilot for cheminformatics and an open-source effort known as Biopipe also exists. While some of the workflow capabilities of these platforms overlap with the VIBE platform (which supports the technology of the present invention), none of these platforms include educational aspects or mechanisms for educational support.

The current invention provides a set of unique and novel features that function on INCOGEN's existing Visual Integrated Bioinformatics Environment (VIBE) software, which successfully demonstrates the application of visual programming for life science and bioinformatics in a research environment. The Visual Integrated Bioinformatics Environment (VIBE) is a state-of-the-art, drag-and-drop analysis workflow management environment and that has been established as a premier software application in the field of bioinformatics workflow management during the last several years. The VIBE system interfaces with a variety of environments, including high-throughput platforms such as Sun Microsystems'® (Grid Engine and the TimeLogic DeCypher® bioinformatics hardware accelerator platform. The rich visualization and data mining environments in combination with the sophisticated multi-tiered server architecture offer life science researchers and bioinformaticists a powerful system for data analysis, data mining and knowledge discovery. The VIBE Software Development Kit (SDK) enhances the VIBE environment with user-level extensibility.

The features of VIBE include, but are not limited to, visual workflow creation, customization, and management, robust toolkits, efficient drag-and-drop analysis pipeline construction, visual implementation of software algorithms and all TimeLogic DeCypher®-accelerated algorithms, data filtering on simple or complex criteria, distributed multi-user support, interactive or batch mode module execution, user editable representation of pipelines in XML, state-of-the-art interactive visualization tools, real-time visualization of dataflow between the modules in the workflow pipeline, intuitive and user-friendly data representation, and archiving of workflows and results for future use.

### SUMMARY OF INVENTION

The current invention pertains to the education-oriented features layered upon the existing VIBE platform using the terminology “Visual Integrated Bioinformatics Environment for Education” (VIBE-Ed). In addition to the features of VIBE described above, VIBE-Ed includes; user-editable module descriptions, personal real-time tracking of activity within the software, integrated application overview page(s), a quick reference guide, integrated introductory multimedia tutorials, a hot-linked glossary, intelligent personalized tutors, a library of primers, multimedia assessments, entertainment features and educational error messages.

This system aids in combining each or any of the above mentioned features to provide a tool for training in life science analysis. The tool allows student(s) or researcher(s), regardless of their previous computer programming experience, to explore life science and bioinformatics concepts and tools and to integrate various analysis tools, teaching resources, and assessment methods into the application or integrated curriculum with little effort. The usefulness of such a tool in the classroom enables students, researchers and instructors to experience a significant reduction in the number of hours in start-up and initial familiarity with the topics than would otherwise be required.

### DETAILED DESCRIPTION OF THE INVENTION

The current invention, which is incorporated into an existing software application, is known as ‘Visual Integrated Bioinformatics Environment for Education’ (VIBE-Ed) and provides researchers and students who may have limited computer programming experience with a user-friendly, intuitive, and education-oriented visual programming interface. Thus, it addresses the critical bottleneck in life science and bioinformatics, which is a lack of sufficiently trained bioinformaticists. The existing VIBE workflow environment supplies the foundation into which VIBE-Ed incorporates instructional features to aid in the teaching of life science and bioinformatics theory and concepts and to provide first-hand experience in the use of relevant computational tools.

VIBE-Ed uses the VIBE platform and supporting features of VIBE, which are described below:

VIBE Enterprise Architecture:

The design of VIBE incorporates Java 2 Enterprise Edition (J2EE) object-oriented architecture standards. These standards yield a robust and flexible multi-tiered system. The multi-tiered design allows the system to be scalable and extensible and provides many design advantages, including;
(a) Reduced overall system cost without loss of performance or flexibility through modular, distributed components.
(b) Isolation of the client from the business logic and storage format of the data, allowing flexibility in the middle layers of the system (application server configuration, database servers and schemas) without modifications to the client.
(c) Ability to distribute the application layer to increase system performance.
(d) Independent analysis on the application server layer without client intervention.

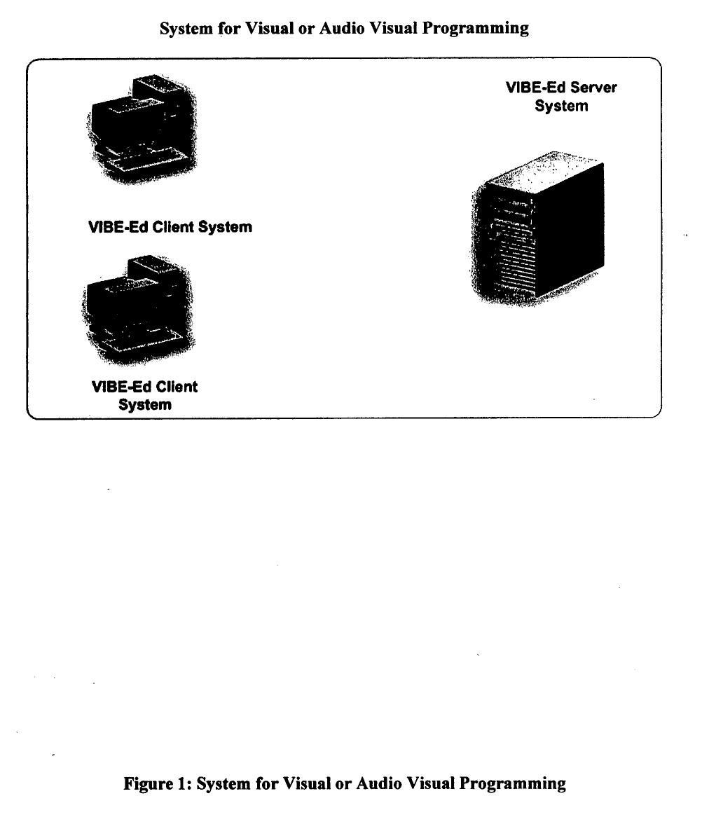

The VIBE system can be described and characterized by two parts; namely, the server system and the client system, as depicted in FIG. 1.

Main services provided by the server system include, but are not limited to, remote execution of computationally intensive tasks as per the user's preferences, storage of workflow pipelines, storage of modules in a central repository so that they are available to all the clients connecting to the server, management of algorithms and databases containing data for sequence comparison and other analyses.

Main services provided by the client system include, but are not limited to, providing a visual programming environment for workflow pipeline development, modification and testing. Moreover, the educational features of the current invention are layered primarily over the client system, which makes the system desirable for life science educational and research purposes.

Visual Workflow Creation:

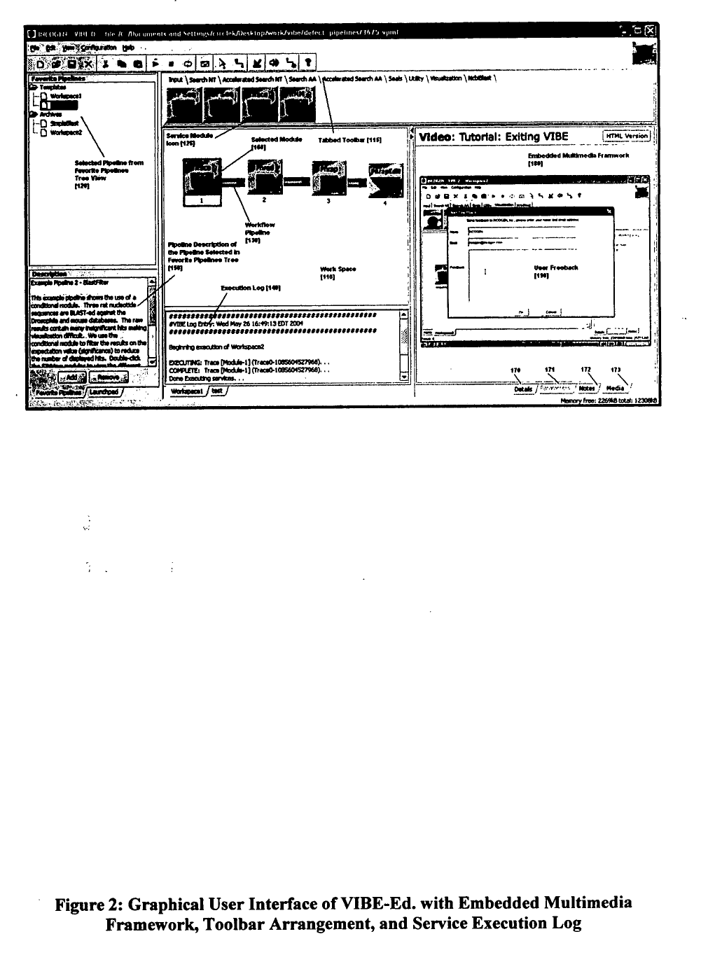

VIBE provides a graphical drag-and-drop interface to create workflows or pipelines (FIG. 2) from a wide selection of tools and algorithms. FIG. 2 shows the modules for similarity searches arranged in a toolbar format. The groupings are determined by arrangement of an XML file that can be customized by the user.

Analysis modules are grouped by type and presented to users as icons on a toolbar or a tree view. The icons represent modules that can be dragged onto the workspace and connected to other modules to generate a workflow pipeline for data analysis. Users can choose among modules including but not limited to: data input, sequence similarity searches, sequence alignment, databases, utilities such as email notification agents and data filters, model building and searching, and visualization tools. The interface shown indicates an embedded multimedia framework, toolbar arrangement, and service execution log.

Each analysis module contains a set of default parameters and may be executed with the default settings. The parameters can also be easily adjusted through a separate tabular interface. The program also provides detailed descriptions in hypertext format for all analysis modules. This description of individual modules can be edited by users for further clarification or to add notes regarding results of tests conducted using these modules or description of changes made to these modules by a user.

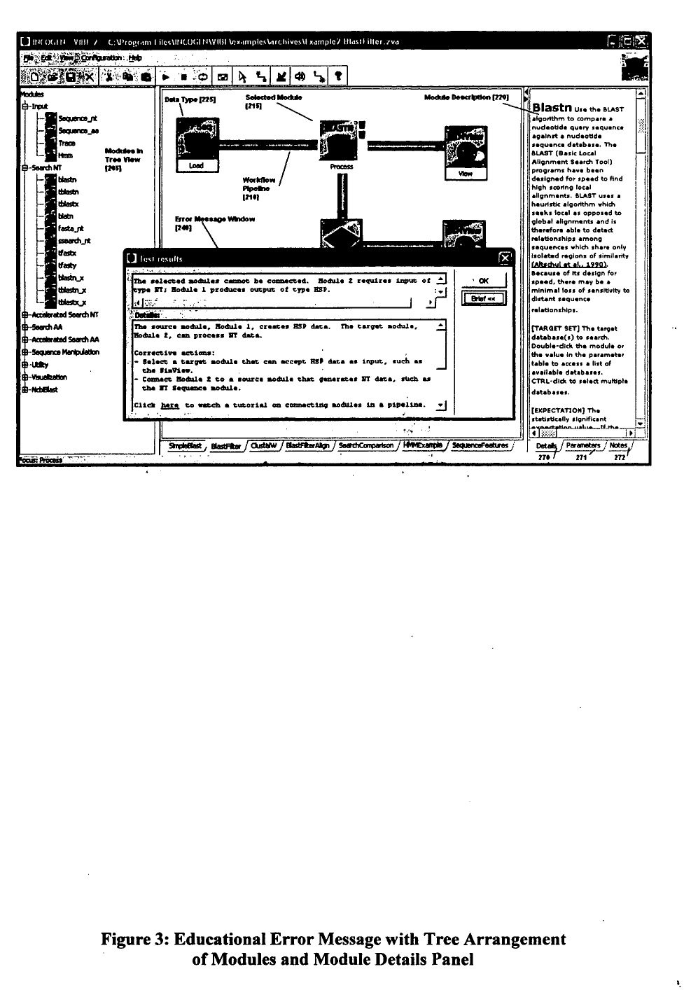

VIBE-Ed provides connection validation at design time to assist users in creating valid workflows and to reduce the probability of a runtime error or conflict due to incompatibility of modules. Only those modules that are compatible with each other are allowed to be connected to form a workflow pipeline. An error dialog box, as shown in FIG. 3, is displayed if a user tries to join two modules that are not compatible with each other. This error dialogue box (test results) will contain an intuitive message to resolve the error(s) and/or will contain a link to an appropriate resource that will help the user to determine the cause of the error.

Once generated, a workflow pipeline can be saved as XML on the client computer or on any network-accessible machine. A pipeline can be saved before execution as a template (that is, with no data associated with it) and used later with other input data sets or it can be saved as an archive during or after the execution to capture all associated data and results that exist at that time. The user can re-open the saved archive at any later point and view the saved results or conduct further analysis. Multiple workspaces also allow users to design new pipelines while continuing to monitor the progress of active pipelines that are being executed. Through the simple graphical interface, users may employ tools such as alert modules and data filter modules to diverge data flow. A user could stop the pipeline while in execution and save it along with the partly processed data and later resume execution from the same point. The flow of data during the execution of a workflow pipeline can be observed visually.

State-of-the-art, interactive visualization tools are available for each analysis module to efficiently and interactively present the user with the most important results of each analysis.

VIBE SDK (Software Development Kit):

Due to the continuously evolving nature of the life science and bioinformatics fields, new algorithms and comparison techniques are becoming available very rapidly. Modules that are incorporated within life sciences or bioinformatics software often quickly become obsolete due to the progressive availability of better applications and modules for data analysis. The VIBE platform enables the user to incorporate these new modules and independent applications into workflow pipelines with very little effort or programming expertise. This technological innovation of the modular architecture of the software makes the system a powerful and extensible framework and will allow the incorporation of additional tools as they become available.

The VIBE software includes a software development kit (SDK) that allows users to incorporate their own tools or third party modules through a simple set of public interfaces. Due to the interdisciplinary nature of bioinformatics, it is unfortunately necessary for researchers to have both biological knowledge and computational skills to not only perform analysis using tools, but also to develop their own models and utilities for enhancing the collection of available methods. Through the VIBE SDK, users can very quickly add their own specialized tools to a pipeline for use with existing tools and datasets. Hence VIBE-Ed minimizes the necessity for computer programming expertise and allows the student or researchers to concentrate on problems related to their specific analysis.

The VIBE SDK exposes an integrated Application Programming Interface (iAPI) to the system via four succinct Java classes and their methods accompanied with extensive documentation and guidelines for using the SDK. The VIBE SDK provides mechanisms for adding tools that are executed locally on the client's machine, that are executed remotely through one or more VIBE servers, and that are accessible via a web-enabled interface such as SOAP (Simple Object Access Protocol) or CGI (Common Gateway Interface). It also provides the ability to add visualization tools or process utilities for execution within the VIBE client interface itself.

Sharing:

The enterprise architecture of VIBE described above allows users of the system to share the workflow pipelines (with or without data) and results of the workflow pipeline analysis among themselves. Thus, researchers may advance their work on already available results and also share their results and workflow pipeline(s) (with or without data) with fellow researchers and students.

Features of VIBE-ED (Current Invention)

The previous description provides information regarding some of the fundamental features of the VIBE platform that are necessary for supporting the current invention. The current invention, known as ‘Visual Integrated Bioinformatics Environment for Education’ (VIBE-Ed), augments VIBE with the educational features, described below, necessary to allow for an ideal software for life science and bioinformatics education and research.

Error Reporting:

During pipeline construction, VIBE presents a message to the user when a connection cannot be established between two modules as requested by the user. For VIBE-Ed, this error dialog box will be extended to contain an educational or instructional message to resolve the error(s) and/or will contain a link to an appropriate resource that will help the user to understand the cause of the error.

Integrated Overview Page:

A page listing and describing the tools available in VIBE-Ed is integrated as part of the software and may be loaded during application startup as per the user's preferences. This page may be accessed anytime by the user through the VIBE-Ed menu. This overview page helps a first time user to get acquainted with the software environment and get initial tips on how to use the software without any formal training or experience.

Quick Reference Guide:

A Quick Reference Guide is available with the VIBE-Ed software which presents the user with an electronic reference guide for performing basic functions. It includes instructions on performing basic functions as well as shortcuts to tutorials, hot keys and other quick tips on using the software.

Introductory Video:

The user is presented with a set of narrative videos showing actions on the screen commonly performed in VIBE-Ed in order to introduce a user to basic methods and concepts of the software framework, eliminating the need for training even for a first time user of the application.

Hot-Linked Glossary:

A glossary of terms pertaining to life science, bioinformatics and VIBE-Ed software is specifically built into the software. Glossary entries that are encountered elsewhere in the program are hot-linked from the word to direct the user to its definition in the glossary. Moreover, an authorized user, such as an instructor can modify or append this glossary in order to add more information or additional terminology pertaining to life science or bioinformatics.

Personalized Tutors:

An interactive help feature is included in the software that will become activated when certain errors occur and is searchable by the user when a problem or question is encountered. Additionally, this helper will “remember” certain actions or mistakes made by the user and customization will occur as per the usage pattern that directs the user to an appropriate resource or generates a hint that will help the user to resolve the query.

Library of Primers:

Topics pertaining to life science and bioinformatics are explained in a Library of Primers that is accessible to the user. Students will be directed to these primers by clicking on related tools in VIBE-Ed. A core group of primers will be provided with the software which can be further modified or appended by an authorized user such as an instructor. In addition, a server will host a library of third-party primers, from which VIBE-Ed instructors may obtain and submit new primers in order to customize their curriculum and share with other life science instructors.

Multimedia Tutorials:

Certain topics in VIBE-Ed will be further explained through multimedia tutorials in which the user is guided through the steps of certain types of analyses by the software. These may pertain to the usage of the software or to life science or bioinformatics topics or both.

Multimedia Assessments:

The VIBE-Ed software incorporates a utility to test the user's knowledge about topics introduced through the VIBE-Ed tutorial as well as life science topics in general. A basic set of such quizzes is included in VIBE-Ed. Additionally, an instructor or an authorized user can design a quiz or an exam that will include questions to be answered by the student to test the concepts related to life science and VIBE-Ed software. The results of these exercises and quizzes can be uploaded and made available to an authorized user in order to track the progress of the class or individual students.

Educational Entertainment Features (“Edutainment”):

Games and other forms of entertainment are integrated into VIBE-Ed to provide an entertaining aspect to the learning process. These may involve “networked” games in which the students in the class cooperate with each other to perform life science and bioinformatics analysis, and each student can see the other students' progress and contributions to the game.

Auto Update:

To keep the client systems up-to-date with the rapid changes in tools and knowledge of life science and bioinformatics, features such as Primers and Tutorials are automatically updated, upon approval from an authorized user, when new features become available. Moreover, due to the modular nature of the utilities incorporated into the system, any of the utilities explained above can be automatically updated through the auto-update feature. The auto-update utility connects to the support server to alert the user regarding availability of updates for the software. Based on the user preference these updates are downloaded and installed on the system.

Tracking System:

A log will be generated each time a student uses VIBE-Ed, and actions such as the following will be tracked: analysis pipeline construction, parameter changes, and errors made by the student. These logs can be examined and tracked by an authorized user such as an instructor. This tracking system will also incorporate a utility that will allow a student to submit questions or comments to the instructor. The tracking system incorporates options such as history files and extensive error logs as well as individual student assessments thereby providing specific tailoring for educational purposes. These features will help students to organize their feedback and comments about both the software and the topics. The features will provide increased reliability of the feedback and will improve efficiency in the further development of the system and curriculum. The tracking results can also be sent to the server. Hence, they will help developers to understand the way students try to use the program and thus allow further development by updating tutorials accordingly.

Lesson Planner:

The VIBE-Ed software also incorporates a lesson planner that will allow an instructor to design the course curriculum for a semester or an academic term. Suggested curricula will be available to the instructor, to which he or she can add material and share curricula plans with other VIBE-Ed instructors through the resources kept on a centralized server. The lesson planner feature will also include an instructor homepage where the instructor can access reports of student progress such as tracking logs and assessment results, and can communicate with students by a bulletin board or through communication with individual users.

The above key features of the VIBE-Ed system drastically reduce the learning curve for research biologists and life science students and thus, enable them to gain hands-on instruction in life science and bioinformatics tools without prior knowledge of computer programming. The learning curve associated with VIBE-Ed is expected to be minimal, providing an ideal environment for teaching the next generation of life science students and bioinformaticists about tools available to them. The user interface will provide extensive built-in documentation that will describe each available tool in detail. Students will be able to learn how to use each tool by easily manipulating parameters, rerunning analyses and comparing the results. The interface will also provide an ideal platform to teach students about subtle differences between tools, including which tool is most appropriate for any given task. In addition, the interface provides a means for showing the technical aspects such as the XML and Java® code used in communicating the data among various tools. This knowledge will significantly improve the students' efficiency and contributions in their future life science and bioinformatics careers.

The design of the current invention combines expertise in different areas to significantly advance the life science educational environment. The challenge that is addressed is the need for a system that teaches complex life science and bioinformatics concepts in a easy to understand environment, allowing students to gain hands-on experience using the concepts taught in a classroom and having those concepts reinforced through software experiments simultaneously.

### DETAILED DESCRIPTION OF THE DRAWINGS

FIG. 1 is a schematic diagram of the VIBE system comprising the visual or audio-visual programming environment of the current invention. The system could have one or more server(s) and one or more client(s).

FIG. 2 is a screenshot of the VIBE-Ed graphical user interface with an embedded multimedia framework, toolbar arrangement of available modules, and a service execution log. FIG. 2 displays the modules arranged in a tabbed toolbar format. Different categories of the modules are arranged in the tabbed format (115), while individual modules within each category are displayed as icons (125) in the toolbar. These icons can be dragged and dropped into the workspace in order to create a work-flow pipeline. The top-center region (110) is the user workspace where different modules can be dragged and dropped in order to create a workflow pipeline (130). The workflow pipeline consists of modules that are arranged sequentially as shown in the figure. Each module except the first module in the pipeline receives data from the previous module. Each module except the last module in the pipeline processes the data that it received and passes it across to the next module. The window on the left side (120) contains archives and/or templates that have been published for group use or added by the user. The lower-left-hand side window (150) contains the description of the selected archive or template. On the right-hand side is a tabbed window wherein clicking individual tabs displays different information regarding the selected module. Clicking on the Details tab (170) displays the module details as shown in the figure. Clicking on the Parameters tab (171) displays the module parameters, which can be modified by the user, and clicking on Notes tab (172) displays the user-editable notes regarding the workflow pipeline or module. Clicking on the Media tab (173) displays the Embedded Multimedia Framework window (180), where the user may, for example, watch a tutorial video. The window at bottom-center (140) displays the service execution log. The service execution log is generated as the workflow pipeline is executed and helps the user to monitor the progress of the execution. It also helps the user detect any errors that occurred during the execution of the workflow pipeline.

FIG. 3 is a screenshot of VIBE-Ed with an educational error message, tree arrangement of modules, and a module details panel. FIG. 3 includes an error message (240) indicating that a user is trying to join two incompatible modules in a workflow pipeline (210). In this example, module 1 creates high-scoring pairs (HSP) data, representing results from a sequence similarity search; the target module, module 2, however, can only process raw nucleotide (NT) data. Only modules that are compatible can be connected within a workflow pipeline. The error message window includes a hyperlink to allow the user to connect to an appropriate tutorial that will explain the error and aid the user in avoiding the error in the future. FIG. 3, in the left window, displays the modules in an expandable tree view (205). The right window displays the module description (220) of the selected module (215). Clicking on the Details tab (270) displays the module details as displayed in the figure. Clicking on the Parameters tab (271) displays the module parameters, which can be modified by the user, and clicking on the Notes tab (272) displays the user-editable notes regarding the workflow pipeline or module.

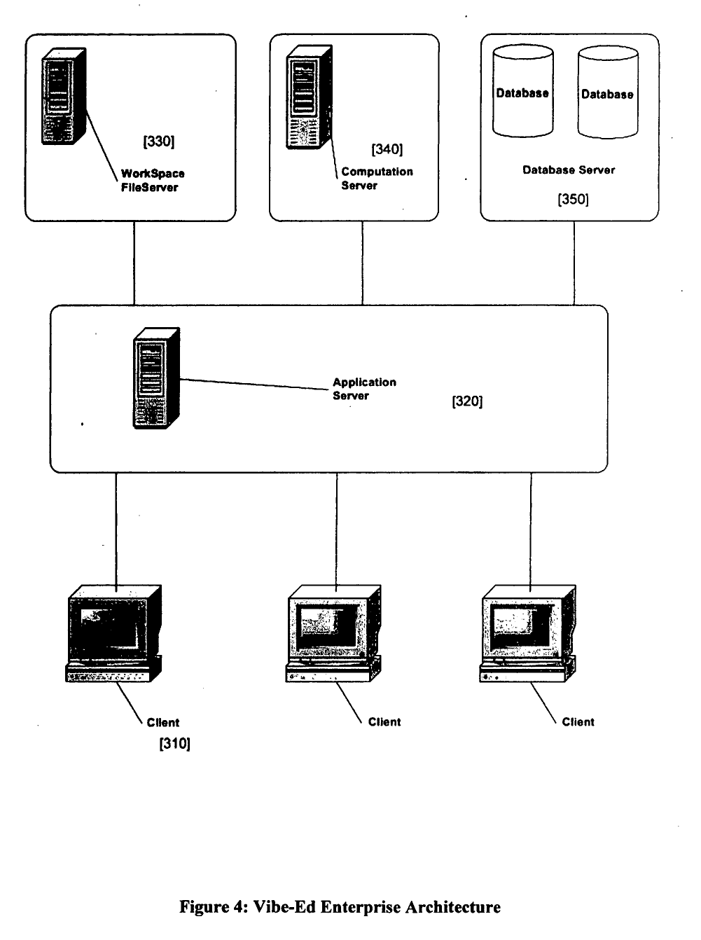

FIG. 4 is a schematic diagram representing the Enterprise Architecture of VIBE-Ed. The VIBE-Ed clients (310) are connected to the VIBE-Ed Application Server (320) which in turn is connected to a database server (350), computation server (340) and a workspace server (330). Computationally intensive tasks during the execution of the workflow are sent to the computation server. Data related to analyses is stored at the database server while archived and shared workflow pipelines are stored in the workspace server (330).

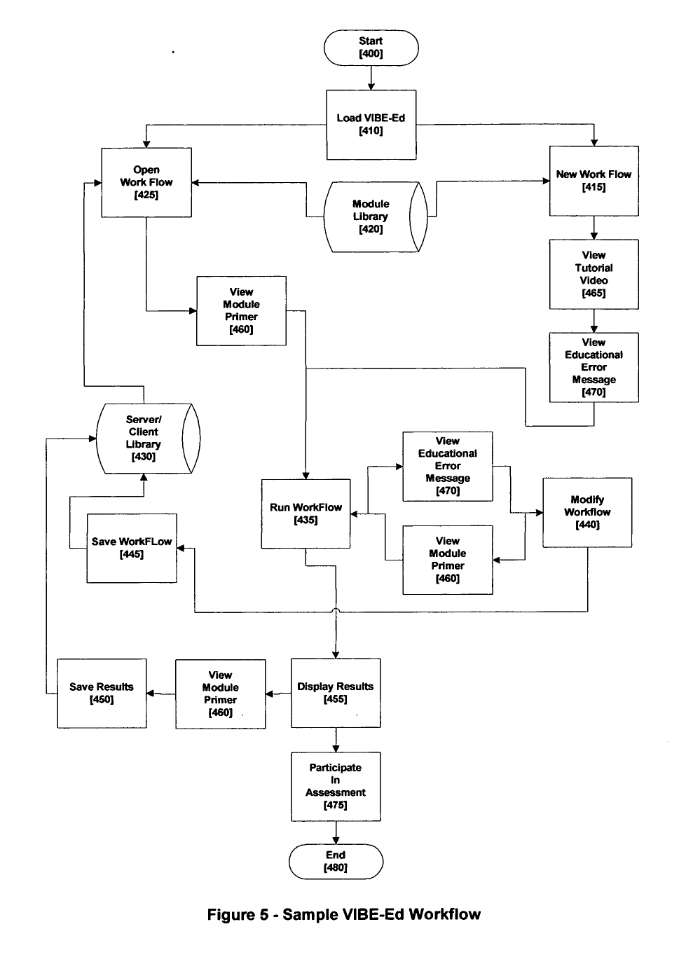

FIG. 5 is a flowchart representing the functionality of the VIBE-Ed application. When a user first loads the VIBE-Ed client (410) she/he has an option of either creating a new workflow pipeline from scratch (415) by using modules available in the library (420) or using an existing workflow from the server earlier saved by the user or shared by other user(s) (425) and modifying it. While using the VIDE-Ed application, a user may view a tutorial video (465) in the software for assistance. For example, a new user might view the tutorial video for information on how to create a new workflow pipeline. Additionally, during this process, educational error messages (470) are available. Once the workflow is constructed with compatible modules it can be executed (425) or it can be saved in the repository (445). When a user opens a workflow, module primers (460) are available to view. Workflow execution can be interrupted and saved with partially processed data. After the workflow has finished execution, the results are displayed with the help of visualization tools (455). The workflow can be further modified (440) to receive better analysis. The results can be saved in the repository (450) for further analysis. Once results have been displayed, the user has the option of participating in an assessment (475). After the user is finished using the VIBE-Ed system it can be closed (480).

1. A life science educational visual or audio-visual programming environment system comprising:
a. one or more server system(s);
b. one or more client system(s);
c. a repository of modules located on said client system and/or said server system;
d. a repository of workflow pipelines created by user(s) of said visual or audio-visual programming environment;
e. an interface to view a detailed description of said modules when said modules are selected and/or highlighted;
f. a grading utility to allow instructor(s) to grade students working on said visual or audio-visual programming environment;
g. a tracking utility to track the activity of said user(s) of said visual or audio-visual programming environment;
h. a multimedia training tool to allow said user(s) to learn to use said visual or audio-visual programming environment;
i. an error reporting tool that will alert said user(s) when an error is encountered within said visual or audio-visual programming environment;
j. a personalized tutor that is customizable to an individual user;
k. a library of primers and/or a multimedia training tool that will explain topics pertaining to life science;
l. a multimedia assessment tool that will test said user's understanding of said topics pertaining to life science;
m. one or more sharing utilities to allow said users of said visual or audio-visual programming environment to share resources including but not limited to said repository of modules, said repository of workflow pipelines, and said library of primers directly between said client systems or via said server computer;
n. an entertainment utility that will help said user(s) to learn said system while playing game(s);
o. a teaching planner that will help said user(s) to design course curriculum;
p. an auto-update tool that will update said client and/or said server system.

2. The client system and/or said server system of claim 1, wherein said modules are computer software programs provided with said visual or audio-visual programming environment or developed by said user or obtained from a third party.

3. The tracking utility of claim 1, wherein said utility within said visual or audio-visual programming environment will automatically record and save user activity when said visual or audio-visual programming environment is employed.

4. The visual programming environment of claim 1, wherein said modules are represented as visual icons in formats including but not limited to tabbed toolbar format or tree format.

5. The multimedia training tool of claim 1, comprising one or more interactive multimedia tutorials that provide a step-by-step guide for various functionalities regarding said visual or audio-visual programming environment or life science topics.

6. The sharing utility of claim 1, wherein said sharing utility is a computer software program incorporated in said visual or audio-visual programming environment that will allow said user to save said workflow pipeline(s) in a central repository which can be used by said user(s) of said visual or audio-visual programming environment.

7. The sharing utility of claim 1, wherein said user may retrieve said workflow pipeline(s) stored by other said user(s) of said visual or audio-visual programming environment.

8. The visual or audio-visual programming environment of claim 1, wherein said environment serves as an integrated development environment allowing interaction between said user(s) and said visual or audio-visual programming environment.

9. The interaction of claim 8, wherein said interaction includes but is not limited to development of said workflow pipeline(s), modification of said workflow pipeline(s), testing of said workflow pipeline(s), and saving of said workflow pipeline(s).

10. The visual or audio-visual programming environment of claim 1, wherein said visual or audio-visual programming environment may optionally present an overview page that contains a description of utilities available within said visual or audio-visual programming environment.

11. The error reporting tool of claim 1, wherein said tool will direct said user to appropriate resource(s).

12. The library of primers of claim 1, wherein said library may be extended, appended or modified by (an) instructor(s).

13. The personalized tutor of claim 1, wherein said tutor monitors and assists said user through operations including but not limited to directing said user to appropriate resource(s).

14. The multimedia assessment tool of claim 1, wherein said tool may facilitate evaluation of said user's knowledge of life science;

15. The multimedia assessment tool of claim 14, wherein said tool may further upload the results of the said evaluation to a repository.

16. The repository of claim 15, wherein said repository can be accessed by an authorized user to track the progress of a student or a class.

17. The autoupdate tool of claim 1, wherein said tool will automatically notify and optionally update said system comprising said client system and said server system by downloading components wherein said components are downloaded from a server.

18. The autoupdate tool of claim 1, wherein said tool may update said repository of modules or template(s) of said workflow pipeline(s) or said sharing utility or said grading utility or said tracking utility or said multimedia training tool or said error reporting tool or said personalized tutor or said multimedia assessment tool or said library of primers or said autoupdate tool itself or any combination thereof.

19. The visual programming environment of claim 1, wherein said visual or audio-visual programming environment runs on any graphical user interface based operating system including but not limited to Microsoft Windows, Linux, Sun Solaris and Mac OS that support Java Virtual Machine.

20. The visual or audio-visual life science educational programming environment of claim 1, wherein computationally intensive tasks on said client system may optionally be sent to said server system.
